(19) United States
(12) Patent Application Publication
(10) Pub. No.: US 2025/0334047 A1
(43) Pub. Date: Oct. 30, 2025

(54) DOWNHOLE TOOL, WELL SYSTEM, AND METHOD EMPLOYING A SENSOR POSITIONED PROXIMATE A SPINNING FEATURE OF A DOWNHOLE DEVICE, THE SENSOR CONFIGURED TO SENSE FOR A CHANGE IN NOISE EMANATING FROM THE SPINNING FEATURE

(71) Applicant: Halliburton Energy Services, Inc., Houston, TX (US)

(72) Inventors: Ryan W. McChesney, Carrollton, TX (US); Gordon McLeary, Carrollton, TX (US); Georgina Corona Cortes, Carrollton, TX (US); Stephen Michael Greci, Carrollton, TX (US)

(21) Appl. No.: 19/187,364

(22) Filed: Apr. 23, 2025

Related U.S. Application Data
(60) Provisional application No. 63/638,264, filed on Apr. 24, 2024.

(51) Int. Cl. E21B 47/12; G01D 5/26

(52) U.S. Cl. CPC E21B 47/12; G01D 5/268

(57) ABSTRACT

Provided is a downhole tool, a well system, and a method. The downhole tool, in one aspect, includes a downhole device, the downhole device including a spinning feature associated therewith. The downhole tool, in accordance with another aspect, includes a sensor positioned proximate the spinning feature of the downhole device, the sensor configured to sense for and send uphole operational data originating from the spinning feature of the downhole device, the operational data in the form of a change in noise emanating from the spinning feature of the downhole device.

### CROSS-REFERENCE TO RELATED APPLICATION

This application claims the benefit of U.S. Provisional Application Ser. No. 63/638,264, filed on Apr. 24, 2024, entitled “METHOD OF USING DOWNHOLE CABLE TO CONFIRM DOWNHOLE VALVE ACTUATION,” commonly assigned with this application and incorporated herein by reference in its entirety.

### BACKGROUND

Wellbores are sometimes drilled into subterranean formations to produce one or more fluids from the subterranean formation. For example, a wellbore may be used to produce one or more hydrocarbons. Where fluids are produced from a long interval of a formation penetrated by a wellbore, it is known that balancing the production of fluid along the interval can lead to reduced water and gas coning, and more controlled conformance, thereby increasing the proportion and overall quantity of oil or other desired fluid produced from the interval.

Various devices and completion assemblies have been used to help balance the production of fluid from an interval in the wellbore. For example, various flow control devices have been used, in certain embodiments in conjunction with well screens, to restrict the flow of produced fluid through the screens for the purpose of balancing production along an interval.

### BRIEF DESCRIPTION

Reference is now made to the following descriptions taken in conjunction with the accompanying drawings, in which:

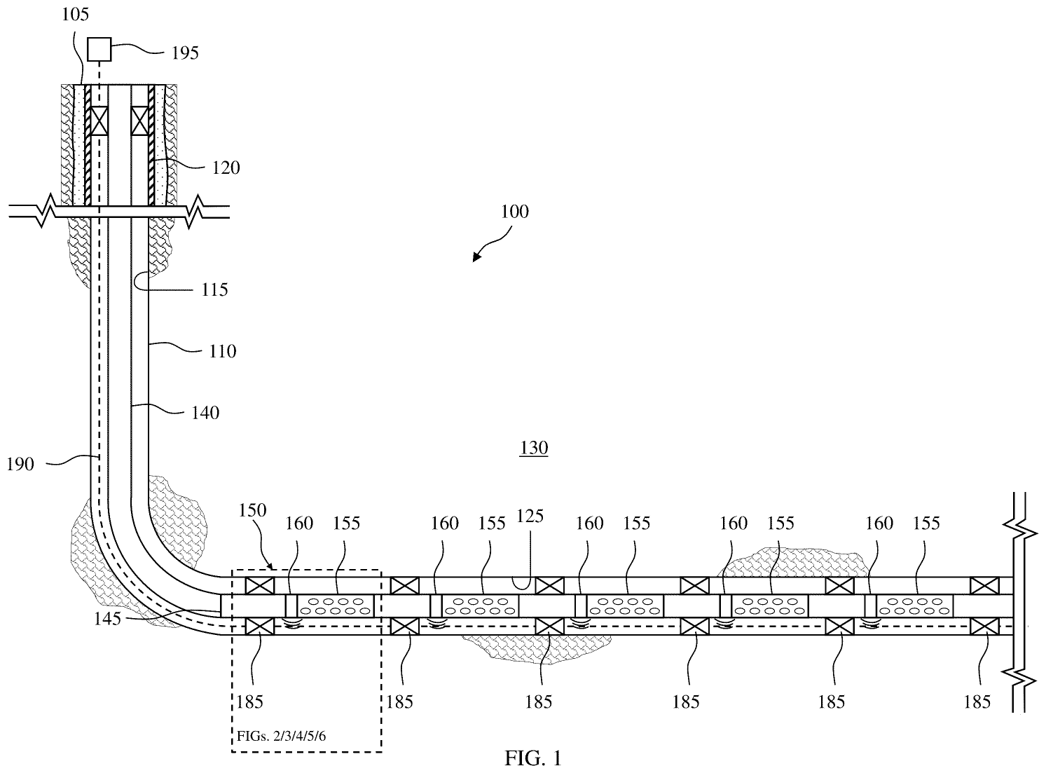

FIG. 1 illustrates a well system including a downhole tool, for example including one or more flow control devices, designed, manufactured and/or operated according to one or more embodiments of the disclosure;

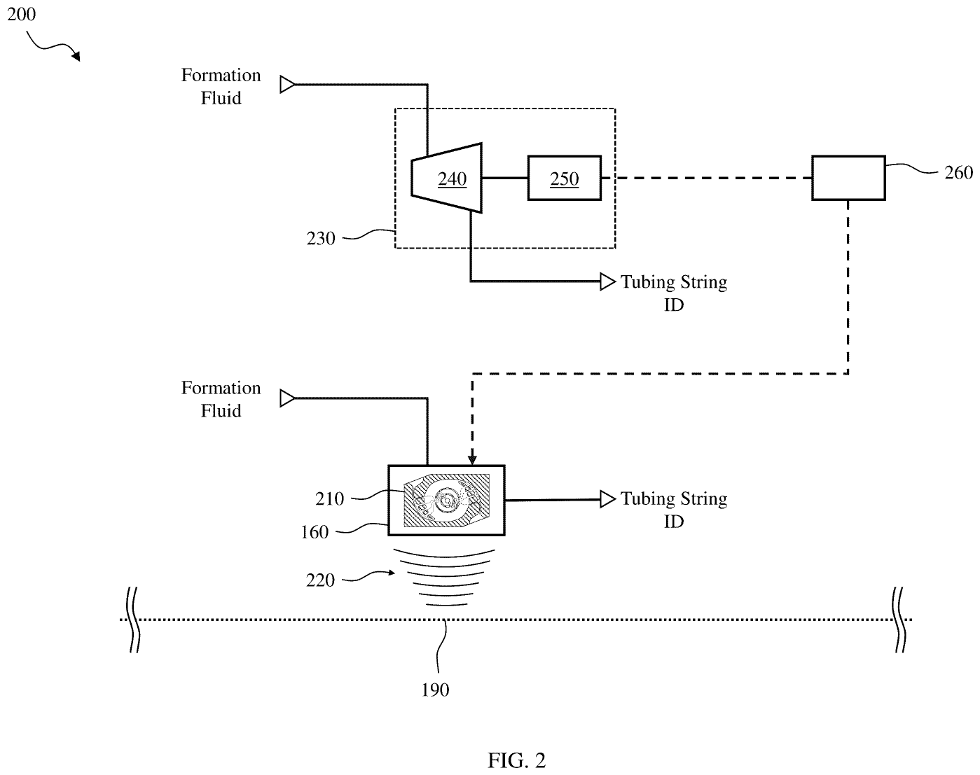

FIGS. 2 through 6 illustrate alternative embodiments of a downhole tool designed, manufactured, and/or operated according to one or more embodiments of the disclosure, for example as might be used in the well system of FIG. 1;

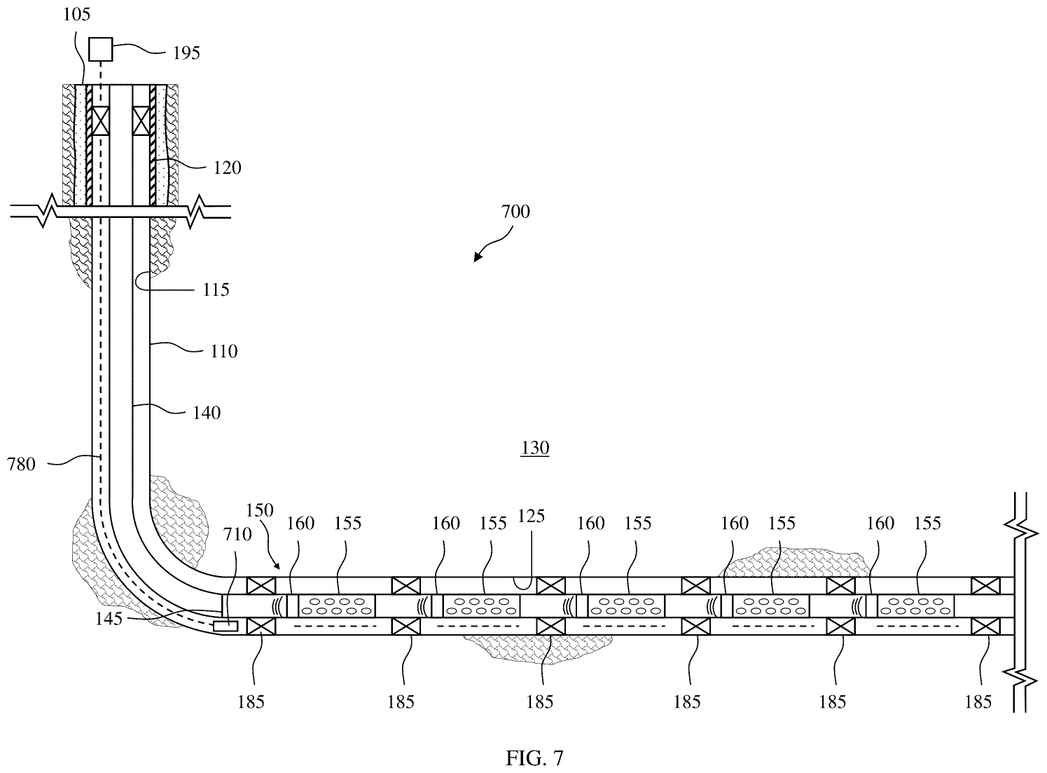

FIG. 7 illustrates a well system including a downhole tool, for example including one or more flow control devices, designed, manufactured and/or operated according to one or more alternative embodiments of the disclosure; and

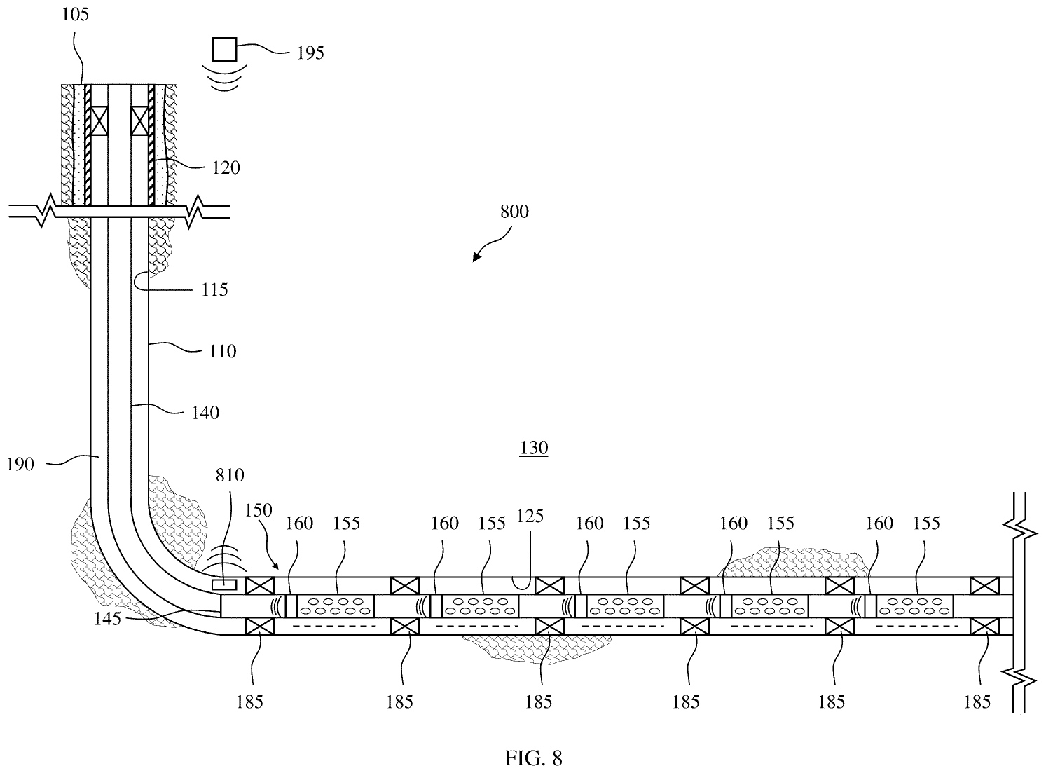

FIG. 8 illustrates a well system including a downhole tool, for example including one or more flow control devices, designed, manufactured and/or operated according to one or more alternative embodiments of the disclosure.

### DETAILED DESCRIPTION

In the drawings and descriptions that follow, like parts are typically marked throughout the specification and drawings with the same reference numerals, respectively. The drawn figures are not necessarily to scale. Certain features of the disclosure may be shown exaggerated in scale or in somewhat schematic form and some details of certain elements may not be shown in the interest of clarity and conciseness. The present disclosure may be implemented in embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed herein may be employed separately or in any suitable combination to produce desired results.

Unless otherwise specified, use of the terms “connect,” “engage,” “couple,” “attach,” or any other like term describing an interaction between elements is not meant to limit the interaction to direct interaction between the elements and may also include indirect interaction between the elements described. Furthermore, unless otherwise specified, use of the terms “up,” “upper,” “upward,” “uphole,” “upstream,” or other like terms shall be construed as generally toward the surface of the subterranean formation; likewise, use of the terms “down,” “lower,” “downward,” “downhole,” “downstream,” or other like terms shall be construed as generally toward the bottom, terminal end of a well, regardless of the wellbore orientation. Use of any one or more of the foregoing terms shall not be construed as denoting positions along a perfectly vertical axis. Additionally, unless otherwise specified, use of the term “subterranean formation” shall be construed as encompassing both areas below exposed earth and areas below earth covered by water such as ocean or fresh water.

Various values and/or ranges are explicitly disclosed in certain embodiments herein. However, values/ranges from any lower limit may be combined with any upper limit to recite a range not explicitly recited. Similarly, values/ranges from any lower limit may be combined with any other lower limit to recite a range not explicitly recited. In the same way, values/ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited. Similarly, an individual value disclosed herein may be combined with another individual value or range disclosed herein to form another range.

The terms “substantially XYZ,” “about XYZ,” “approximately XYZ.” as used herein, means that it is within 10 percent of perfectly XYZ. The term “significantly XYZ,” as used herein, means that it is within 5 percent of perfectly XYZ. The term “ideally XYZ,” as used herein, means that it is within 1 percent of perfectly XYZ. The monicker “XYZ” could refer to parallel, perpendicular, alignment, or other relative features disclosed herein.

The present disclosure is based, at least in part, on a recognition that current downhole tools that include downhole flow control devices (e.g., inflow control devices such as production devices, outflow control devices such as injection devices, whether electronic, non-electronic, mechanical, etc.), while capable of receiving wireless down-link signals/data from a surface of the wellbore (e.g., for operation/control thereof), are generally incapable of sending up-link signals/data (e.g., wireless up-link signals/data) to the surface of the wellbore. For example, in the embodiment wherein the flow control device is an inflow control device (ICD), wireless down-link signals may be sent from the surface of the wellbore to the ICD to instruct the opening and/or closing thereof. Nevertheless, as there is no wired connection to the ICD, there is an inability to send up-link data (e.g., position of the ICD) back uphole.

In at least one example, traditional downhole tools including flow control devices receive a telemetry down-link (surface to downhole) of signals/data via a fluid harmonics approach. For example, the production flow rate may be varied using surface automation to signal a device to open and/or close a throttle valve or control an electrical submersible pumps (ESP's) RPM. The device may then decode these changes as variance in generator output frequency, corresponding to either a 0 or 1 that is part of a command sequence that will either direct the micro controller to open or close the valve. A gain, as there is no wired connection to the ICD, there is an inability to send up-link data (e.g., position of the ICD) back uphole.

The present disclosure, recognizing that up-link data from the flow control devices to the surface of the wellbore would be highly valuable, has developed various downhole tools, well systems, and methods for wirelessly collecting data associated with the flow control devices and transmitting that data as an up-link (e.g., wired up-link, wireless up-link, or an up-link including a combination thereof) to the surface of the wellbore. In at least one embodiment, the present disclosure has developed one or more sensing devices that can detect one or more variables associated with the flow control devices. In at least one embodiment, the one or more sensing devices can determine the movement of a valve within the flow control devices, and/or whether that movement is towards a closed position or towards an open position, etc., In at least one other embodiment, the one or more sensing devices can determine a position of the valve within the flow control devices. In one or more embodiments, the one or more sensing devices can determine the spinning, rate of spinning, change in rate of spinning, etc., of a turbine associated with the flow control devices. In at least one other embodiment, the one or more sensing devices can determine the spinning of a feature of a generator associated with the turbine. In at least one other embodiment, the one or more sensing devices can determine a health of the flow control devices and associated devices, whether it be of the valve, the turbine associated therewith, etc. In yet another embodiment, the one or more sensing devices can determine a type and/or composition (e.g., oil, gas, water, water cut, etc.), volume, flow rate, viscosity, density, flow perturbance, etc. of the fluid flowing through the flow control devices, for example by sensing any of the features discussed above.

In at least one embodiment, the one or more sensing devices are configured to sense a change in a noise being generated by the flow control devices or associated devices to determine the one or more variables. The term “noise,” unless otherwise required herein, includes acoustic noise, vibration noise, electronic noise, mechanical noise, fluidic noise, etc. This change in noise may be indicative of the movement of the flow control device's valve, the position of the flow control device's valve, spinning and/or degree of spinning of its turbine of another spinning feature associated with the downhole tool, the movement of the generator (e.g., movement of the rotor of the generator), the health of the fluid control device or devices associated therewith, type and/or composition (e.g., oil, gas, water, water cut, etc.), volume, flow rate, viscosity, density, etc. of the fluid flowing through the flow control device, etc.,

In at least one other embodiment, the one or more sensing devices are configured to sense a change in an electronic value and/or mechanical value of a movable feature of the flow control device. For example, the one or more sensing devices could be used to determine a movement and/or physical position (e.g., exact physical position) of a movable feature (e.g., valve, piston, etc.) of the flow control device, whether that is being determined mechanically, electrically, fluidically, etc.,

The above provides a great deal of information, thus providing a number of benefits over well systems that are designed and/or manufactured today. For example, in at least one embodiment the flow control device is an autonomous electronic ICD (autonomous eICD), and thus the autonomous eICD is configured to autonomously open and/or close based upon the composition of the fluid flowing therethrough. Traditionally, the operator of the well system would not know of the autonomous changes in the eICDs, particularly on an eICD by eICD basis. The present disclosure, however, would allow for such data and/or information to be gathered using the one or more sensors, again by the changes in the noise and/or physical location of the valves, and then send that information to the surface of the wellbore (e.g., via the up-link).

With this information now having been collected, a number of different mechanisms may be used to up-link this data to the surface. In at least one embodiment, a fiber optic cable may be run downhole within the wellbore proximate the downhole tool, for example including the one or more flow control devices and devices associated therewith. The fiber optic cable, in this embodiment, could sense for the noise/data generated by the flow control device and/or associated devices. In at least one embodiment, the fiber optic cable would employ distributed acoustic sensing (DAS), also known as distributed fiber optic sensing (DFOS) to listen for the noise. This embodiment would not require any connections or additional hardware at each downhole tool that includes the one or more flow control devices. In yet another embodiment, hydrophones are coupled to the cable (e.g., fiber-optic hydrophones (FOHs) when a fiber optic cable is used, or electronic hydrophones when an electrical cable is used). In either embodiment, among others, the collected data may be sent uphole (e.g., as an up-link). In yet another embodiment, each of the flow control devices could wirelessly transmit their encoded data in a number of different short hops (e.g., much like a mesh network) until that data makes it way to the surface of the wellbore. In yet another embodiment, each of the flow control devices could wirelessly transmit their encoded data in a number of different short hops until that data makes its way to a downhole central collection module (e.g., a DynaLink® Telemetry System, which allows real-time bi-directional communication between downhole tools and the surface of the wellbore, as might be obtained from Halliburton, Inc.), which could then send the combined data to the surface of the wellbore. This wireless transmission of the encoded data is particularly useful across a junction (e.g., boundary) between the lower completion and the upper completion, which otherwise would require one or more somewhat problematic wet connects for the wired transmission there across. Such a system could include a decoder module (e.g., whether uphole at the surface of the wellbore, or alternatively downhole between the one or more fluid control devices and the surface of the wellbore) that could decode the information received from the downhole tools (e.g., one or more flow control devices and/or associated devices), including as to type of information, value of the information, location of the downhole tool providing the information, etc . . . .

FIG. 1 illustrates a well system 100 including a downhole tool, for example including one or more flow control devices, designed, manufactured and/or operated according to one or more embodiments of the disclosure. In the illustrated embodiment of FIG. 1, a wellbore 110 extends from a surface 105 through various earth strata. The wellbore 110, in the illustrated embodiment, has a substantially vertical section 115, the upper portion of which has installed therein a casing string 120. The wellbore 110, in the illustrated embodiment, also has a substantially horizontal section 125, which extends through a hydrocarbon bearing subterranean formation 130. In the illustrated embodiment, a portion of the substantially vertical section 115 and the substantially horizontal section 125 of the wellbore 110 are open-hole. While an entirety of the substantially horizontal section 125 of the wellbore 110 is shown as open-hole, aspects of the disclosure will work in any orientation, whether open-hole or cased-hole.

Positioned within wellbore 110 and extending from the surface 105 is a tubing string 140. Tubing string 140 provides a conduit for fluids to travel from formation 130 upstream to the surface 105, as well as travel from the surface 105 downstream to the formation 130. In at least one embodiment, a downhole tool 150 designed, manufactured, and/or operated according to one or more embodiments of the disclosure is positioned within the wellbore 110. The downhole tool 150, in at least one embodiment, includes a plurality of production tubing sections 155 and one or more flow control devices 160 positioned within the tubing string 140. The plurality of flow control devices 160 may comprise any of those discussed in the paragraphs above. In one or more embodiments, at either end of each production tubing section 155 is a packer 185, the packer 185 providing a fluid seal between the tubing string 140 and the wall of the wellbore 110. The space in-between each pair of adjacent packers 185 defines a production interval.

Each of the production tubing sections 155 may optionally include sand control capability. Sand control screen elements or filter media associated with production tubing sections 155 are designed to allow fluids to flow therethrough but prevent particulate matter of sufficient size from flowing therethrough. In an embodiment, the filter media is of the type known as “wire-wrapped,” since it is made up of a wire closely wrapped helically about a wellbore tubular, with a spacing between the wire wraps being chosen to allow fluid flow through the filter media while keeping particulates that are greater than a selected size from passing between the wire wraps. It should be understood that the generic term “filter media” as used herein is intended to include and cover all types of similar structures, which are commonly used in gravel pack well completions and permit the flow of fluids through the filter or screen while limiting and/or blocking the flow of particulates (e.g. other commercially-available screens, slotted or perforated liners or pipes; sintered-metal screens; sintered-sized, mesh screens; screened pipes; prepacked screens and/or liners; or combinations thereof). Also, a protective outer shroud having a plurality of perforations therethrough may be positioned around the exterior of any such filter medium.

Through the use of the flow control devices 160 of the present disclosure, some control over the volume and/or composition of the produced fluids is enabled. For example, in an oil production operation, if an undesired fluid component, such as water, steam, carbon dioxide, or natural gas, is entering one of the production intervals, the flow control device in that interval may be adjusted (e.g., will autonomously adjust) to restrict or resist production of the undesired fluid from that interval. It will be appreciated that whether a fluid is a desired or an undesired fluid depends on the purpose of the production or injection operation being conducted. For example, if it is desired to produce oil from a well, but not to produce water or gas, then oil is a desired fluid and water and gas are undesired fluids.

The fluid flowing into the production tubing section 155 typically comprises more than one fluid component. Typical components are natural gas, oil, water, steam, and/or carbon dioxide. The proportion of these components in the fluid flowing into each production tubing section 155 will vary over time and based on conditions within the formation 130 and wellbore 110. Likewise, the composition of the fluid flowing into the various production tubing sections 155 throughout the length of the entire tubing string 140 can vary significantly from section to section. The well system 100, in one or more embodiments, is designed to reduce or restrict from any particular interval the production of undesired fluids. Accordingly, a greater proportion of desired fluid component (e.g., oil) will be produced into the wellbore interior.

Although FIG. 1 depicts one flow control device 160 in each production interval, it should be understood that any number of flow control devices 160 of the present disclosure can be deployed within a production interval without departing from the principles of the present disclosure. Likewise, the inventive flow control devices do not have to be associated with every production interval. They may only be present in some of the production intervals of the wellbore 110 or may be in the wellbore 110 interior to address multiple production intervals.

The well system 100, in the illustrated embodiment of FIG. 1, additionally includes a sensor 190 (e.g., a cable), for example in one embodiment positioned in an annulus between the wellbore 110 and the tubing string 140. The sensor 190 (e.g., a cable), which in at least one embodiment is a fiber optic cable, extends from the surface of the wellbore 110 toward the one or more flow control devices 160. In the illustrated embodiment of FIG. 1, the sensor 190 (e.g., a cable) extends from the surface of the wellbore 110 down to at least the lowest most flow control device 160. Accordingly, in at least this one embodiment, the sensor 190 (e.g., a cable) traverses a junction 145 between a lower completion and an upper completion. In at least this one embodiment, the sensor 190 (e.g., a cable) may include one or more wet-connect devices, such that an uphole portion of the sensor 190 (e.g., a cable) may properly couple with a downhole portion of the sensor 190 (e.g., a cable), for example as the upper completion engages with the lower completion.

In the illustrated embodiment, the sensor 190 (e.g., a cable), or at least portions of sensors 190 (e.g., cables), are located radially outside of the one or more flow control devices 160 (e.g., in the annulus between the one or more flow control devices 160 and the wellbore 110). In at least this one embodiment, the sensor 190 (e.g., a cable), or at least portions of sensors 190 (e.g., cables), are positioned for sensing noise (e.g., as discussed above) associated with the one or more flow control device 160.

In at least on embodiment, the sensor 190 (e.g., a cable) is coupled (e.g., wired or wirelessly coupled) to a decoder module 195. The decoder module 195 may be positioned at various different locations within the well system 100. Nevertheless, in the embodiment of FIG. 1, the decoder module 195 is positioned at the surface of the wellbore 110. The decoder module 195, in at least one embodiment, is configured to receive the operational data from the sensor 190 (e.g., a cable) (e.g., combined operational data from the sensor 190 (e.g., a cable)) and thereafter convert such operational data into useable information.

Turning to FIG. 2, illustrated is one example embodiment of a downhole tool 200 designed, manufactured and/or operated according to one or more embodiments of the disclosure, for example as might be used in the well system 100 of FIG. 1. The downhole tool 200 is similar in many respects to the downhole tool 150 of FIG. 1. Accordingly, like reference numbers may be used to indicate similar, if not identical, features.

The downhole tool 200 of FIG. 2 includes a flow control device 160. As shown in the embodiment of FIG. 2, the flow control device 160 is coupled with the tubing string, the flow control device configured to allow fluid to pass between an outside diameter (OD) of the tubing string and an inside diameter (ID) of the tubing string (e.g., tubing string 140 of FIG. 1). The flow control device 160 may comprise any of the flow control devices disclosed above, as well as any currently known or hereafter discovered flow control devices while staying within the scope of the disclosure. As disclosed above, in at least one embodiment, the flow control device 160 is an inflow control device (ICD). As disclosed, in at least one other embodiment, the inflow control device (ICD) is a fluidic diode based inflow control device (ICD). In at least one other embodiment, the fluidic diode based inflow control device is a density autonomous inflow control device (aICD) 210, such as is shown in FIG. 2.

The downhole tool 200 of FIG. 2 additionally includes a sensor 190 positioned proximate the flow control device 160. As disclosed above, the sensor 190 may comprise a variety of different sensors and remain within the scope of the disclosure. For example, in at least one embodiment, the sensor 190 is a cable, such as an electric cable employing an electronic hydrophone. In yet another embodiment, the sensor 190 is a distributed acoustic sensor (DAS) cable. In yet another embodiment, the sensor 190 is a distributed fiber optic sensor (DFOS) cable.

In one or more embodiments, the well system includes an upper completion and a lower completion associated with the tubing string, a junction being formed between the upper completion and the lower completion. In at least this one embodiment, the distributed acoustic sensor (DAS) cable or distributed fiber optic sensor (DFOS) cable extends from a surface of the wellbore past the junction and to an annulus between the flow control device 160 and the wellbore (e.g., wellbore 110 of FIG. 1).

In the illustrated embodiment of FIG. 2, the sensor 190 is configured to sense for and send uphole operational data originating from the flow control device 160, the operational data in the form of a change in noise 220 emanating from the flow control device 160. The change in noise 220 may vary greatly based upon the design of the downhole tool 200. For example, in at least one embodiment, the change in noise 220 is a change in acoustic noise, a change in vibration noise, a change in electronic noise, or a change in mechanical noise emanating from the flow control device 160. In yet another embodiment, the change in noise 220 is a change in fluidic noise emanating from the flow control device 160, such as is the case when the flow control device 160 includes the fluidic diode based inflow control device (ICD) or density autonomous inflow control device (aICD) 210. This change in fluidic noise, and the operational data it represents, in at least one embodiment, is indicative of a health of the flow control device 160, type of fluid flowing through the flow control device 160, composition of fluid flowing through the flow control device 160, density of fluid flowing through the flow control device 160, viscosity of fluid flowing through the flow control device 160, volume of fluid flowing through the flow control device 160, or flow rate of fluid flowing through the flow control device 160. Those skilled in the art, given the present disclosure, would be able to calculate the above operational data when given the change in noise data of the flow control device 160, for example using a decoder module (e.g., decoder module 195 of FIG. 1).

The downhole tool 200 of FIG. 2, in one or more embodiments, further includes a downhole power source 230 (e.g., placed below the junction between the upper completion and the lower completion, and in certain embodiments within the production interval) as well as circuitry 260 coupled thereto. The downhole power source 230 may comprise a variety of different downhole power sources and remain within the scope of the disclosure. For example, in at least one embodiment the downhole power source 230 is a battery or other power source, for example to provide power to the circuitry 260 (e.g., localized circuitry, such as located within the production interval). In an even other embodiment, the downhole power source 230 is a downhole power generation source that includes a turbine 240 and generator 250. The turbine 240, and generator 250 coupled thereto, in the illustrated embodiment, convert fluidic energy from the formation fluid to energy for powering the circuitry 260 (e.g., circuit board, such as a printed circuit board) and/or the associated flow control device 160 coupled thereto. In this embodiment, the turbine 240, generator 250, and circuitry 260, thus provide the power for the flow control device 160 to operate as intended, including opening and closing a fluid path between the subterranean formation (e.g., subterranean formation 130 of FIG. 1) and the tubing string (e.g., tubing string 140 of FIG. 1).

In the illustrated embodiment of FIG. 2, the flow control device 160 provides the noise 220 that the sensor 190 (e.g., fiber optic cable in one embodiment) senses and communicates to the surface of the wellbore (e.g., wellbore 110 of FIG. 1). The noise 220, in this embodiment, may be any of the noises disclosed above, including acoustic noise, vibration noise, electronic noise, mechanical noise, fluidic noise, etc., Nevertheless, in the embodiment of FIG. 2, the noise 220 is fluidic noise (e.g., fluid harmonics) as the formation fluid traverses the flow control device 160 (e.g., fluidic diode based inflow control device (ICD) or density autonomous inflow control device (aICD) 210). In at least one embodiment, the sensor 190 includes a hydrophone capable of picking up the fluidic noise.

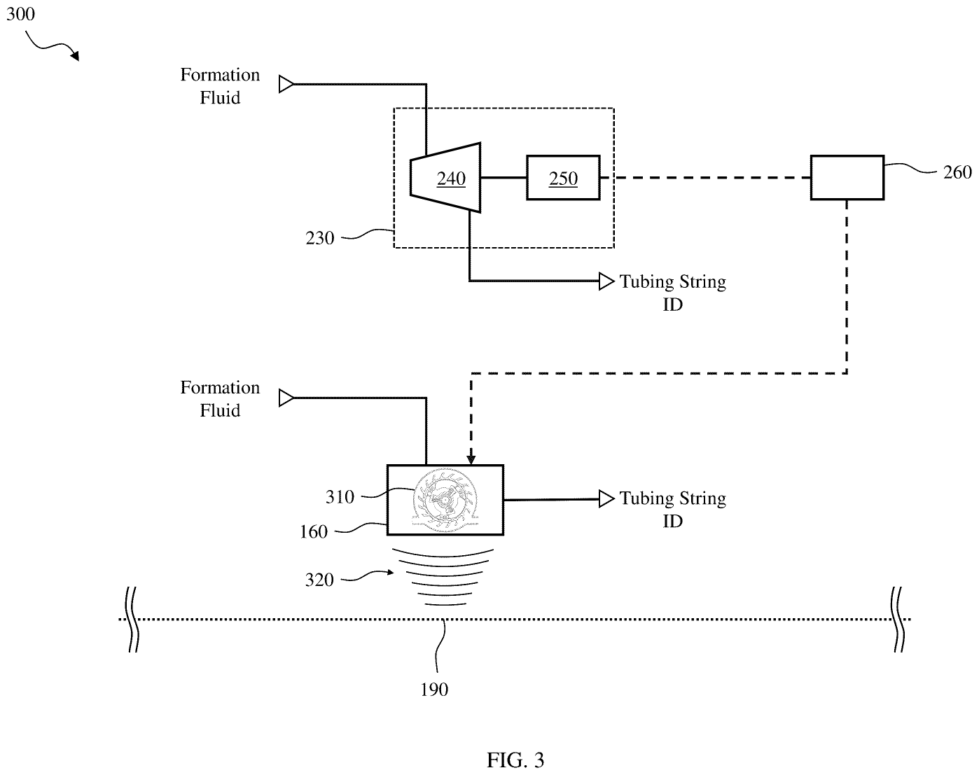

Turning to FIG. 3, illustrated is an alternative embodiment of a downhole tool 300 designed, manufactured and/or operated according to one or more embodiments of the disclosure. The downhole tool 300 is similar in many respects to the downhole tool 200. Accordingly, like reference numbers are being used to indicate similar, if not identical, features. The downhole tool 300 differs, for the most part, from the downhole tool 200, in that the downhole tool 300 includes a spinning feature 310 associated therewith, and the sensor 190 is configured to sense for and send uphole operational data originating from the spinning feature 310 of the downhole device 160, the operational data in the form of a change in noise 320 emanating from the spinning feature 310 of the downhole device 160. The spinning feature 310 may comprise many different designs and remain within the scope of the disclosure. In the illustrated embodiment of FIG. 3, the spinning feature 310 is a spinning turbine, as might form at least a portion of density autonomous inflow control device (aICD).

In at least one embodiment, such as that of FIG. 3, the change in noise 320 is a change in acoustic noise, a change in vibration noise, a change in electronic noise, or a change in mechanical noise emanating from the spinning feature 310. In at least one other embodiment, the change in noise 320 is a change in fluidic noise emanating from the spinning feature 310. For example, the change in noise 320 of the spinning feature 310 could provide operational data uphole, such as a health of the spinning feature, type of fluid driving the spinning feature, composition of fluid driving the spinning feature, density of fluid driving the spinning feature, viscosity of fluid driving the spinning feature, volume of fluid driving the spinning feature, or flow rate of fluid driving the spinning feature.

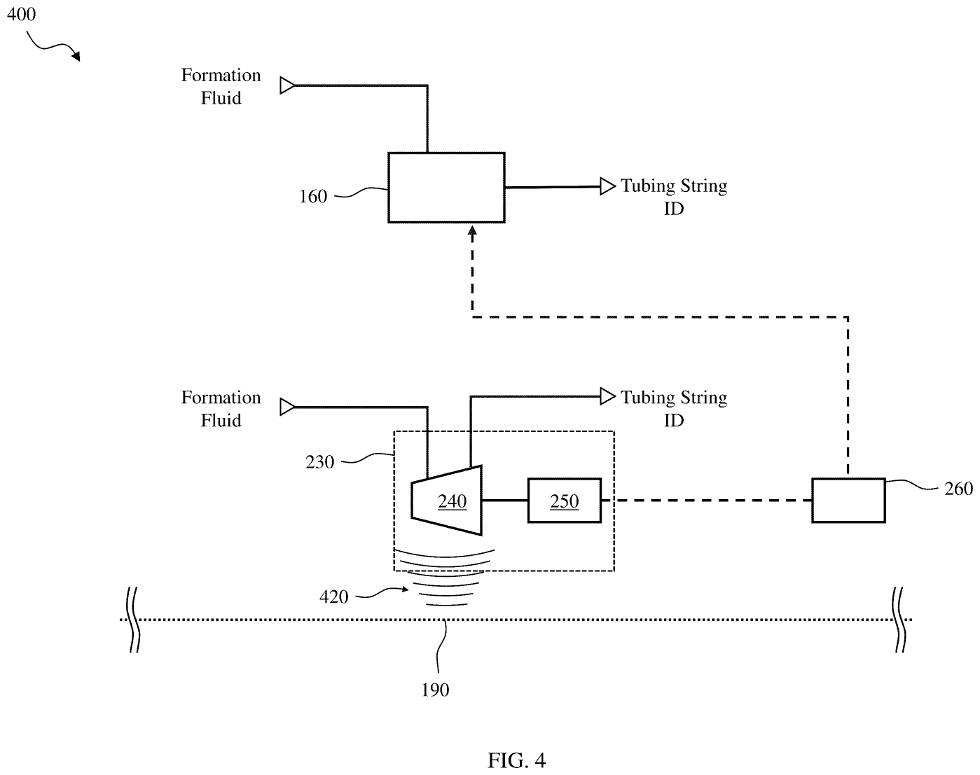

Turning to FIG. 4, illustrated is an alternative embodiment of a downhole tool 400 designed, manufactured and/or operated according to one or more embodiments of the disclosure. The downhole tool 400 is similar in many respects to the downhole tool 300. Accordingly, like reference numbers are being used to indicate similar, if not identical, features. The downhole tool 400 differs, for the most part, from the downhole tool 300, in that the spinning feature that the sensor 190 is sensing for noise 420 from, is the turbine 240 of the downhole power source 230. Thus, in the embodiment of FIG. 4, the noise 420 is not generated by the downhole device 160 (e.g., as shown in FIG. 3), but is generated by the turbine 240. The turbine 240 is designed to be compatible with downhole fluids and/or solids and operate for the life of the well system. The turbine 240 does not require any additional power demand, but in turn provides power to the system.

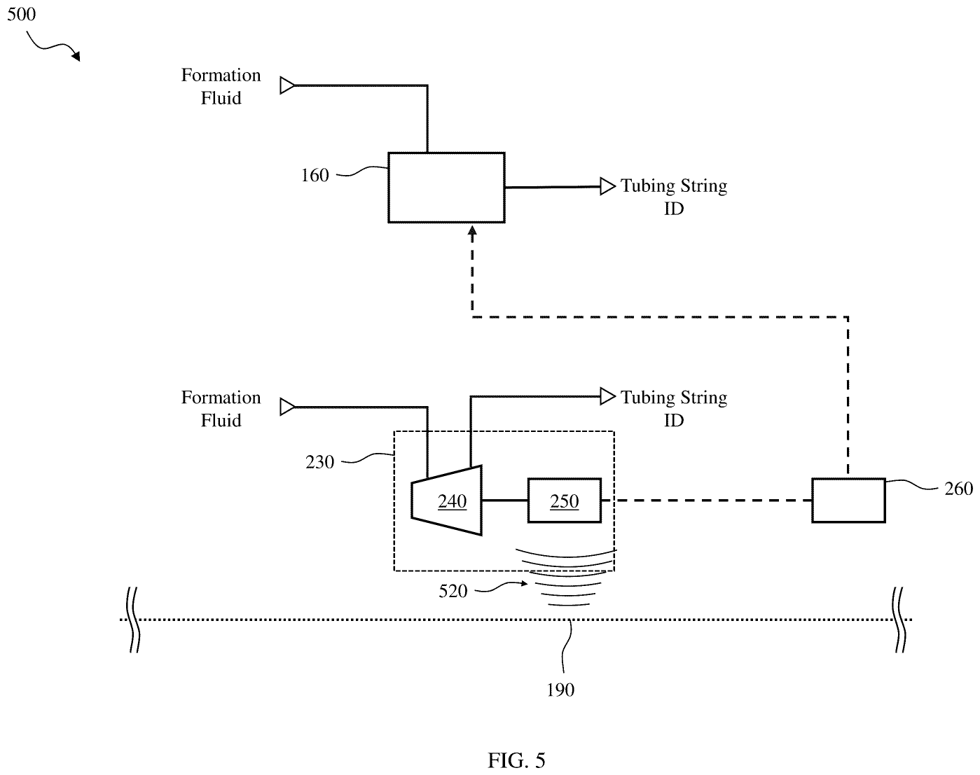

Turning to FIG. 5, illustrated is an alternative embodiment of a downhole tool 500 designed, manufactured and/or operated according to one or more embodiments of the disclosure. The downhole tool 500 is similar in many respects to the downhole tool 400. Accordingly, like reference numbers are being used to indicate similar, if not identical, features. The downhole tool 500 differs, for the most part, from the downhole tool 400, in that the spinning feature that the sensor 190 is sensing for noise 520 from, is the rotor of the generator 250. Thus, in the embodiment of FIG. 5, the noise 520 is not generated by the downhole device 160 (e.g., as shown in FIG. 3), or turbine 240 (e.g., as shown in FIG. 4), but is generated by the spinning feature of the generator 250.

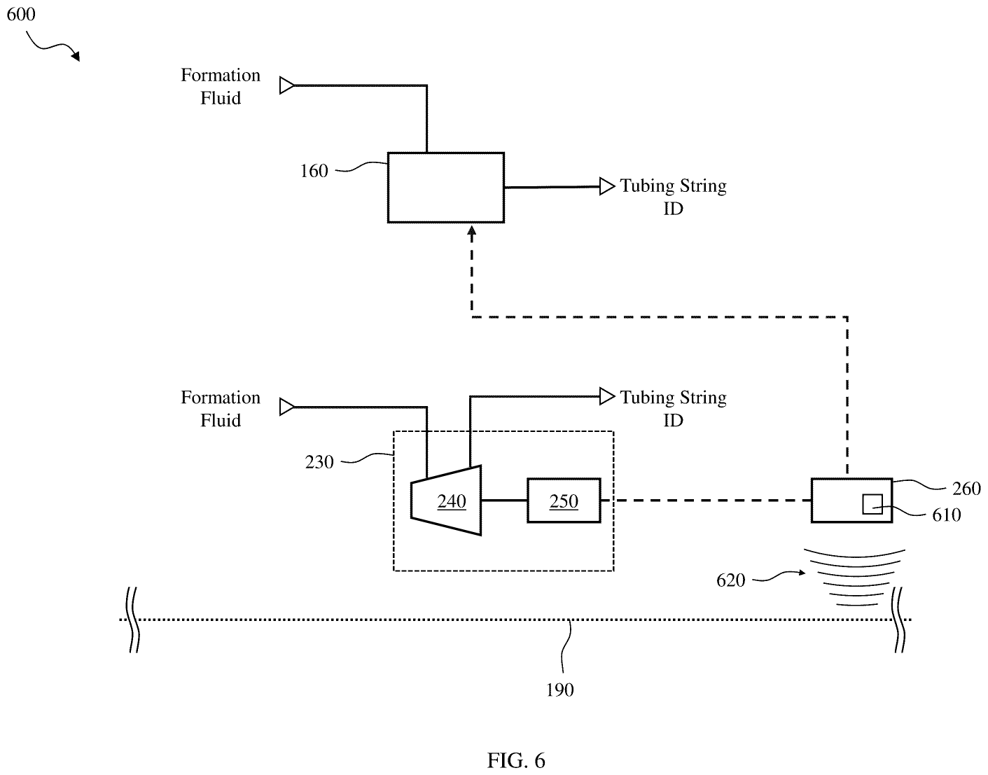

Turning to FIG. 6, illustrated is an alternative embodiment of a downhole tool 600 designed, manufactured and/or operated according to one or more embodiments of the disclosure. The downhole tool 600 is similar in many respects to the downhole tool 500. Accordingly, like reference numbers are being used to indicate similar, if not identical, features. The downhole tool 600 differs, for the most part, from the downhole tool 500, in that the noise 620 is not being generated by the flow control device 160, nor turbine 240, nor generator 250, as in FIGS. 2 through 5, but is generated by a signal noise source 610 coupled with the circuitry 260. In this embodiment, the signal noise source 610 is configured to receive the measured operational data from the circuitry 260 and embed the operational data as noise 620. In turn, the sensor 190 is configured to sense for the noise 620 from the signal noise source 610 and send uphole the operational data embedded within the noise 620. The operational data, in at least one embodiment, is that of any of the features of the downhole tool 600, including that of the downhole device 160 and/or downhole power source 230, as disclosed above, among others.

Turning now to FIG. 7, illustrated is an alternative embodiment of a well system 700 designed, manufactured and/or operated according to one or more embodiments of the disclosure. The well system 700 of FIG. 7 is similar in many respects to the well system 100 of FIG. 1. Accordingly, like reference numbers have been used to indicate similar, if not identical, features. The well system 700 differs, for the most part, from the well system 100 in that the well system 700 employs short hop communications between the various flow control devices 160 before wirelessly communicating that combined data to the sensor 190 (e.g., a cable) uphole of the junction 145 (e.g., to downhole central collection module 710) and ultimately to the decoder module 195 (e.g., via another cable 780). As shown, individual sensors 190 (e.g., individual cable portions) positioned radially outside of the various flow control devices 160 may collect the individual data of the various flow control devices 160.

Turning now to FIG. 8, illustrated is an alternative embodiment of a well system 800 designed, manufactured and/or operated according to one or more embodiments of the disclosure. The well system 800 of FIG. 8 is similar in many respects to the well system 700 of FIG. 7. Accordingly, like reference numbers have been used to indicate similar, if not identical, features. The well system 800 differs, for the most part, from the well system 700 in that the well system 800 employs a downhole central collection module 810 (e.g., a DynaLink® Telemetry System, which allows real-time bi-directional communication between downhole tools and the surface of the wellbore, as might be obtained from Halliburton, Inc.), to wirelessly receive the collected short hop data and transmit that data uphole to the decoder module 195. Again, as shown, individual sensors 190 (e.g., individual cable portions) positioned radially outside of the various flow control devices 160 may collect the individual data of the various flow control devices 160.

### Aspects Disclosed Herein Include:

A. A downhole tool, the downhole tool including: 1) a flow control device coupleable with a tubing string, the flow control device configured to allow fluid to pass between an outside diameter (OD) of the tubing string and an inside diameter (ID) of the tubing string; and 2) a sensor positioned proximate the flow control device, the sensor configured to sense for and send uphole operational data originating from the flow control device, the operational data in the form of a change in noise emanating from the flow control device.

B. A well system, the well system including: 1) a wellbore extending through one or more subterranean formations; 2) a tubing string located in the wellbore; and 3) a downhole tool positioned in the wellbore, the downhole tool including: a) a flow control device coupled with the tubing string, the flow control device configured to allow fluid to pass between an outside diameter (OD) of the tubing string and an inside diameter (ID) of the tubing string; and b) a sensor positioned proximate the flow control device, the sensor configured to sense for and send uphole operational data originating from the flow control device, the operational data in the form of a change in noise emanating from the flow control device.

C. A method, the method including: 1) positioning a downhole tool coupled to a tubing string within a wellbore, the downhole tool including: a) a flow control device coupled with the tubing string, the flow control device configured to allow fluid to pass between an outside diameter (OD) of the tubing string and an inside diameter (ID) of the tubing string; and b) a sensor positioned proximate the flow control device; and 2) sensing for and sending uphole operation data originating from the flow control device, the operational data in the form of a change in noise emanating from the flow control device.

D. A downhole tool, the downhole tool including: 1) a downhole device, the downhole device including a spinning feature associated therewith; and 2) a sensor positioned proximate the spinning feature of the downhole device, the sensor configured to sense for and send uphole operational data originating from the spinning feature of the downhole device, the operational data in the form of a change in noise emanating from the spinning feature of the downhole device.

E. A well system, the well system including: 1) a wellbore extending through one or more subterranean formations; 2) a tubing string located in the wellbore; and 3) a downhole tool positioned in the wellbore, the downhole tool including: a) a downhole device, the downhole device including a spinning feature associated therewith; and b) a sensor positioned proximate the spinning feature of the downhole device, the sensor configured to sense for and send uphole operational data originating from the spinning feature of the downhole device, the operational data in the form of a change in noise emanating from the spinning feature of the downhole device.

F. A method, the method including: 1) positioning a downhole tool within a wellbore having a tubing string, the downhole tool including: a) a downhole device, the downhole device including a spinning feature associated therewith; and b) a sensor positioned proximate the spinning feature of the downhole device; and 2) sensing for and sending uphole operation data originating from the spinning feature of the downhole device, the operational data in the form of a change in noise emanating from the spinning feature of the downhole device.

G. A downhole tool, the downhole tool including: 1) a downhole power source; 3) a downhole device located proximate the downhole power source, the downhole device having circuitry coupled thereto, the circuitry configured to receive power from the downhole power source and measure operational data of the downhole device or downhole power source; 3) a signal noise source coupled with the circuitry, the signal noise source configured to receive the measured operational data from the circuitry and embed the operational data as noise; and 4) a sensor positioned proximate the signal noise source, the sensor configured to sense for the noise and send uphole the operational data embedded within the noise.

H. A well system, the well system including: 1) a wellbore extending through one or more subterranean formations; 2) a tubing string located in the wellbore; and 3) a downhole tool positioned in the wellbore, the downhole tool including: a) a downhole power source; b) a downhole device located proximate the downhole power source, the downhole device having circuitry coupled thereto, the circuitry configured to receive power from the downhole power source and measure operational data of the downhole device or downhole power source; c) a signal noise source coupled with the circuitry, the signal noise source configured to receive the measured operational data from the circuitry and embed the operational data as noise; and d) a sensor positioned proximate the signal noise source, the sensor configured to sense for the noise and send uphole the operational data embedded within the noise.

I. A method, the method including: 1) positioning a downhole tool within a wellbore having a tubing string, the downhole tool including: a) a downhole power source; b) a downhole device located proximate the downhole power source, the downhole device having circuitry coupled thereto, the circuitry configured to receive power from the downhole power source and measure operational data of the downhole device or downhole power source; c) a signal noise source coupled with the circuitry, the signal noise source configured to receive the measured operational data from the circuitry and embed the operational data as noise; and d) a sensor positioned proximate the signal noise source; and 2) sensing for the noise and sending uphole operation data embedded within the noise using the sensor.

Aspects A, B, C, D, E, F, G, H and I have one or more of the following additional elements in combination: Element 1: wherein the flow control device is an inflow control device (ICD). Element 2: wherein the inflow control device (ICD) is a fluidic diode based inflow control device (ICD). Element 3: wherein the inflow control device (ICD) is an autonomous inflow control device (aICD). Element 4: wherein the inflow control device (ICD) is an electronic inflow control device (eICD). Element 5: wherein the change in noise is a change in acoustic noise, a change in vibration noise, a change in electronic noise, or a change in mechanical noise emanating from the flow control device. Element 6: wherein the change in noise is a change in fluidic noise emanating from the flow control device. Element 7: wherein the operational data is a health of the flow control device, type of fluid flowing through the flow control device, composition of fluid flowing through the flow control device, density of fluid flowing through the flow control device, viscosity of fluid flowing through the flow control device, volume of fluid flowing through the flow control device, or flow rate of fluid flowing through the flow control device. Element 8: wherein the sensor is an electric cable employing an electronic hydrophone. Element 9: wherein the sensor is a distributed acoustic sensor (DAS) cable, or distributed fiber optic sensor (DFOS) cable. Element 10: further including an upper completion and a lower completion associated with the tubing string, a junction being formed between the upper completion and the lower completion, and further wherein the distributed acoustic sensor (DAS) cable extends from a surface of the wellbore past the junction and to an annulus between the flow control device and the wellbore. Element 11: wherein the sensor is a distributed fiber optic sensor (DFOS) cable. Element 12: further including an upper completion and a lower completion associated with the tubing string, a junction being formed between the upper completion and the lower completion, and further wherein distributed fiber optic sensor (DFOS) cable extends from a surface of the wellbore past the junction and to an annulus between the flow control device and the wellbore. Element 13: further including an upper completion and a lower completion associated with the tubing string, a junction being formed between the upper completion and the lower completion, and further including a downhole power source positioned downhole of the junction and coupled to the flow control device. Element 14: wherein the downhole power source includes a turbine and a generator, and further including circuitry positioned between the downhole power source and the flow control device. Element 15: wherein the change in noise is a change in acoustic noise, a change in vibration noise, a change in electronic noise, or a change in mechanical noise. Element 16: wherein the change in noise is a change in acoustic noise, a change in vibration noise, a change in electronic noise, or a change in mechanical noise emanating from the flow control device. Element 17: wherein the change in noise is a movement of a movable feature of the flow control device. Element 18: wherein the spinning feature is a spinning turbine. Element 19: wherein the spinning turbine is a spinning power turbine of a downhole power source. Element 20: wherein the spinning feature is a spinning rotor of a downhole power source. Element 21: wherein the change in noise is a change in acoustic noise, a change in vibration noise, a change in electronic noise, or a change in mechanical noise emanating from the spinning feature. Element 22: wherein the change in noise is a change in fluidic noise emanating from the spinning feature. Element 23: wherein the operational data is a health of the spinning feature, type of fluid driving the spinning feature, composition of fluid driving the spinning feature, density of fluid driving the spinning feature, viscosity of fluid driving the spinning feature, volume of fluid driving the spinning feature, or flow rate of fluid driving the spinning feature. Element 24: wherein the sensor is an electric cable employing an electronic hydrophone. Element 25: wherein the sensor is a distributed acoustic sensor (DAS) cable. Element 26: wherein the sensor is a distributed fiber optic sensor (DFOS) cable. Element 27: further including an upper completion and a lower completion associated with the tubing string, a junction being formed between the upper completion and the lower completion, and further wherein the distributed acoustic sensor (DAS) cable extends from a surface of the wellbore past the junction and to an annulus between the spinning feature and the wellbore. Element 28: further including an upper completion and a lower completion associated with the tubing string, a junction being formed between the upper completion and the lower completion, and further wherein distributed fiber optic sensor (D FOS) cable extends from a surface of the wellbore past the junction and to an annulus between the spinning feature and the wellbore. Element 29: wherein the downhole device is a flow control device. Element 30: wherein the flow control device is a fluidic diode based inflow control device (ICD), an autonomous inflow control device (aICD), or an electronic inflow control device (eICD). Element 31: wherein the operational data is a health of the flow control device, type of fluid flowing through the flow control device, composition of fluid flowing through the flow control device, density of fluid flowing through the flow control device, viscosity of fluid flowing through the flow control device, volume of fluid flowing through the flow control device, or flow rate of fluid flowing through the flow control device. Element 32: wherein the downhole power source includes a spinning feature associated therewith. Element 33: wherein the spinning feature is a spinning power turbine or spinning rotor of the downhole power source. Element 34: wherein the operational data is a health of the spinning feature, type of fluid driving the spinning feature, composition of fluid driving the spinning feature, density of fluid driving the spinning feature, viscosity of fluid driving the spinning feature, volume of fluid driving the spinning feature, or flow rate of fluid driving the flow control device. Element 35: wherein the sensor is an electric cable employing an electronic hydrophone. Element 36: wherein the sensor is a distributed acoustic sensor (DAS) cable. Element 37: wherein the sensor is a distributed fiber optic sensor (DFOS) cable. Element 38: further including an upper completion and a lower completion associated with the tubing string, a junction being formed between the upper completion and the lower completion, and further wherein the distributed acoustic sensor (DAS) cable extends from a surface of the wellbore past the junction and to an annulus between the signal noise source and the wellbore. Element 39: wherein the downhole device is a flow control device. Element 40: wherein the flow control device is a fluidic diode based inflow control device (ICD) or a density autonomous inflow control device (aICD). Element 41: wherein the operational data is a health of the flow control device, type of fluid flowing through the flow control device, composition of fluid flowing through the flow control device, density of fluid flowing through the flow control device, viscosity of fluid flowing through the flow control device, volume of fluid flowing through the flow control device, or flow rate of fluid flowing through the flow control device. Element 42: wherein the downhole power source includes a spinning feature associated therewith. Element 43: wherein the spinning feature is a spinning power turbine or spinning rotor of the downhole power source. Element 44: wherein the operational data is a health of the spinning feature, type of fluid driving the spinning feature, composition of fluid driving the spinning feature, density of fluid driving the spinning feature, viscosity of fluid driving the spinning feature, volume of fluid driving the spinning feature, or flow rate of fluid driving the flow control device. Element 45: further including an upper completion and a lower completion associated with the tubing string, a junction being formed between the upper completion and the lower completion, and further wherein distributed fiber optic sensor (DFOS) cable extends from a surface of the wellbore past the junction and to an annulus between the signal noise source and the wellbore.

Those skilled in the art to which this application relates will appreciate that other and further additions, deletions, substitutions and modifications may be made to the described embodiments.

What is claimed is:

1. A downhole tool, comprising:
a downhole device, the downhole device including a spinning feature associated therewith; and
a sensor positioned proximate the spinning feature of the downhole device, the sensor configured to sense for and send uphole operational data originating from the spinning feature of the downhole device, the operational data in a form of a change in noise emanating from the spinning feature of the downhole device.

2. The downhole tool as recited in claim 1, wherein the spinning feature is a spinning turbine.

3. The downhole tool as recited in claim 2, wherein the spinning turbine is a spinning power turbine of a downhole power source.

4. The downhole tool as recited in claim 1, wherein the spinning feature is a spinning rotor of a downhole power source.

5. The downhole tool as recited in claim 1, wherein the change in noise is a change in acoustic noise, a change in vibration noise, a change in electronic noise, or a change in mechanical noise emanating from the spinning feature.

6. The downhole tool as recited in claim 1, wherein the change in noise is a change in fluidic noise emanating from the spinning feature.

7. The downhole tool as recited in claim 5, wherein the operational data is a health of the spinning feature, type of fluid driving the spinning feature, composition of fluid driving the spinning feature, density of fluid driving the spinning feature, viscosity of fluid driving the spinning feature, volume of fluid driving the spinning feature, or flow rate of fluid driving the spinning feature.

8. The downhole tool as recited in claim 1, wherein the sensor is an electric cable employing an electronic hydrophone.

9. The downhole tool as recited in claim 1, wherein the sensor is a distributed acoustic sensor (DAS) cable.

10. The downhole tool as recited in claim 1, wherein the sensor is a distributed fiber optic sensor (DFOS) cable.

11. A well system, comprising:
a wellbore extending through one or more subterranean formations;
a tubing string located in the wellbore; and
a downhole tool positioned in the wellbore, the downhole tool including:
a downhole device, the downhole device including a spinning feature associated therewith; and
a sensor positioned proximate the spinning feature of the downhole device, the sensor configured to sense for and send uphole operational data originating from the spinning feature of the downhole device, the operational data in a form of a change in noise emanating from the spinning feature of the downhole device.

12. The well system as recited in claim 11, wherein the spinning feature is a spinning turbine.

13. The well system as recited in claim 12, wherein the spinning turbine is a spinning power turbine of a downhole power source.

14. The well system as recited in claim 11, wherein the spinning feature is a spinning rotor of a downhole power source.

15. The well system as recited in claim 11, wherein the change in noise is a change in acoustic noise, a change in vibration noise, a change in electronic noise, or a change in mechanical noise emanating from the spinning feature.

16. The well system as recited in claim 11, wherein the change in noise is a change in fluidic noise emanating from the spinning feature.

17. The well system as recited in claim 15, wherein the operational data is a health of the spinning feature, type of fluid driving the spinning feature, composition of fluid driving the spinning feature, density of fluid driving the spinning feature, viscosity of fluid driving the spinning feature, volume of fluid driving the spinning feature, or flow rate of fluid driving the spinning feature.

18. The well system as recited in claim 11, wherein the sensor is an electric cable employing an electronic hydrophone.

19. The well system as recited in claim 11, wherein the sensor is a distributed acoustic sensor (DAS) cable.

20. The well system as recited in claim 19, further including an upper completion and a lower completion associated with the tubing string, a junction being formed between the upper completion and the lower completion, and further wherein the distributed acoustic sensor (DAS) cable extends from a surface of the wellbore past the junction and to an annulus between the spinning feature and the wellbore.

21. The well system as recited in claim 11, wherein the sensor is a distributed fiber optic sensor (DFOS) cable.

22. The well system as recited in claim 21, further including an upper completion and a lower completion associated with the tubing string, a junction being formed between the upper completion and the lower completion, and further wherein distributed fiber optic sensor (DFOS) cable extends from a surface of the wellbore past the junction and to an annulus between the spinning feature and the wellbore.

23. A method, comprising:
positioning a downhole tool within a wellbore having a tubing string, the downhole tool including:
a downhole device, the downhole device including a spinning feature associated therewith; and
a sensor positioned proximate the spinning feature of the downhole device; and
sensing for and sending uphole operation data originating from the spinning feature of the downhole device, the operational data in a form of a change in noise emanating from the spinning feature of the downhole device.

24. The method as recited in claim 23, wherein the spinning feature is a spinning turbine.

25. The method as recited in claim 24, wherein the spinning turbine is a spinning power turbine of a downhole power source.

26. The method as recited in claim 23, wherein the spinning feature is a spinning rotor of a downhole power source.
